(19) United States
(12) Patent Application Publication
(10) Pub. No.: US 2026/0141622 A1
(43) Pub. Date: May 21, 2026

(54) METHOD AND APPARATUS FOR SUPERSAMPLING

(71) Applicant: SAMSUNG ELECTRONICS CO., LTD., Suwon-si (KR)

(72) Inventors: Jaeyoung MOON, Suwon-si (KR); Minjung SON, Suwon-si (KR); Juyoung LEE, Suwon-si (KR); Nahyup KANG, Suwon-si (KR)

(73) Assignee: SAMSUNG ELECTRONICS CO., LTD., Suwon-si (KR)

(21) Appl. No.: 19/076,572

(22) Filed: Mar. 11, 2025

(30) Foreign Application Priority Data
Nov. 19, 2024 (KR) 10-2024-0165424

(51) Int. Cl. G06T 15/20; G06T 3/18; G06T 3/4046; G06T 3/4053; G06T 5/50; G06T 5/60; G06T 7/207; G06T 7/246

(52) U.S. Cl. CPC G06T 15/205; G06T 3/18; G06T 3/4046; G06T 3/4053; G06T 5/50; G06T 5/60; G06T 7/207; G06T 7/248; G06T 2207/20016; G06T 2207/20081; G06T 2207/20084; G06T 2210/36

(57) ABSTRACT

An image processing method may include generating a current image frame at a first resolution by performing jittered sampling on a first-resolution pixel area of a three-dimensional (3D) scene, generating a warped image frame at a second resolution higher than the first resolution, by warping a feedback image frame based on a motion vector corresponding to a difference between the current image frame and a previous image frame, obtaining a position-adjusted warped image by adjusting a position of the warped image frame based on a sampling position change corresponding to the jittered sampling, and generating a current output image frame by processing the current image frame and the position-adjusted warped image frame through a neural network model.

### CROSS-REFERENCE TO RELATED APPLICATION

This application claims priority from Korean Patent Application No. 10-2024-0165424, filed on Nov. 19, 2024, in the Korean Intellectual Property Office, the entire disclosure of which is incorporated herein by reference for all purposes.

### BACKGROUND

### 1. Field of the Invention

Embodiments of the present disclosure relate to a method and apparatus for performing image processing using a supersampling method.

### 2. Description of the Related Art

Three-dimensional (3D) rendering is a branch of computer graphics that renders 3D scenes into two-dimensional (2D) images. 3D rendering may be used in a variety of application areas including 3D games, virtual reality, animation, and movies. A neural network may be trained based on deep learning to perform inference suitable for the purpose of training by mapping input data and output data that are in a non-linear relationship. Such a trained capability of generating a mapping may be referred to as a learning ability of the neural network. Neural networks may be used in a variety of technical fields related to image processing.

### SUMMARY

According to an aspect of the disclosure, an image processing method may include: generating a current image frame at a first resolution by performing jittered sampling on a first-resolution pixel area of a three-dimensional (3D) scene; generating a warped image frame at a second resolution higher than the first resolution, by warping a feedback image frame based on a motion vector corresponding to a difference between the current image frame and a previous image frame; obtaining a position-adjusted warped image by adjusting a position of the warped image frame based on a sampling position change corresponding to the jittered sampling; and generating a current output image frame by processing the current image frame and the position-adjusted warped image frame through a neural network model.

The generating of the current image frame may include: performing the jittered sampling based on a first jitter offset that is predetermined for the first-resolution pixel area of the 3D scene.

The obtaining of the position-adjusted warped image may include: adjusting positions of pixels of the warped image frame so that an area of pixels of the warped image frame corresponds to the current image frame.

The obtaining of the position-adjusted warped image may include: dividing the first-resolution pixel area of the current image frame into subpixels; obtaining a second jitter offset value corresponding to a sampling position adjusted so that positions of the subpixels of the current image frame are included in pixel areas of the warped image frame; and adjusting the position of the warped image frame based on the second jitter offset value.

The adjusting of the position of the warped image frame based on the second jitter offset value may include adjusting the position of the warped image frame so that the warped image frame is matched to a same area as the current image frame whose position is adjusted based on the second jitter offset value.

The adjusting of the position of the warped image frame may include at least one of placing the warped image frame in the same area as the current image frame whose position is adjusted based on the second jitter offset value, by zero-padding and cropping the warped image frame, and placing the warped image frame in the same area as the current image frame whose position is adjusted based on the second jitter offset value, by flipping or reflecting the warped image frame.

The generating of the current output image frame may include matching the position-adjusted warped image frame and the current image frame in dimension, generating a concatenated image by concatenating the current image frame and the position-adjusted warped image frame matched in dimension, and outputting the current output image frame by inputting the concatenated image into the neural network model.

The matching in dimension may include matching in dimension by rearranging the position-adjusted warped image frame to correspond to a depth or a channel of the neural network model by a space-to-depth operation.

The generating of the current image frame may include generating the current image frame by performing jittered sampling on subpixels included in the first-resolution pixel area.

The generating of the current image frame may include performing jittered sampling by selectively sampling respective sampling points corresponding to the subpixels, and the sampling points may be sampled alternately based on a predetermined period.

The neural network model may be configured to output the current output image frame and a feature map corresponding to the current output image frame, and the generating of the warped image frame may include warping the feedback image frame by applying the motion vector to the current output image frame and the feature map.

The neural network model may be configured to receive a first jitter offset and apply a predetermined value corresponding to the first jitter offset to the current output image frame.

The neural network model may be configured to receive a first jitter offset, and output the current output image frame by applying a predetermined value corresponding to the first jitter offset to kernel weight or bias values of layers of the neural network model.

The neural network model may be configured to receive a first jitter offset, and when the neural network model uses a structure of a kernel prediction network, output the current output image frame by applying a predetermined value corresponding to the first jitter offset to a filter of the kernel prediction network.

The predetermined value corresponding to the first jitter offset may include at least one of the first jitter offset, a formula calculated using a value of the first jitter offset, and a value obtained through separate learning using the first jitter offset value as input.

According to another aspect of the present disclosure, there is provided an electronic device including a processor configured to generate a current image frame at a first resolution by performing jittered sampling on a first-resolution pixel area of a three-dimensional (3D) scene based on a first jitter offset, generate a warped image frame at a second resolution higher than the first resolution, by warping a feedback image frame based on a motion vector corresponding to a difference between the current image frame and a previous image frame, obtain a position-adjusted warped image by adjusting a position of the warped image frame based on a sampling position change corresponding to the jittered sampling, and generate an output image frame by processing the jittered sample image frame and the position-adjusted warped image frame through a neural network model, and device display configured to display the current output image frame.

The processor may be configured to adjust positions of pixels of the warped image frame so that an area of the pixels of the warped image frame corresponds to the current image frame.

The processor may be configured to divide the first-resolution pixel area of the current image frame into subpixels, obtain a second jitter offset value corresponding to a sampling position adjusted so that positions of the subpixels of the current image frame are included in the pixel areas of the warped image frame, and adjust the position of the warped image frame based on the second jitter offset value.

The processor may be configured to generate a concatenated image by matching the position-adjusted warped image frame and the current image frame in dimension and concatenating the current image frame and the position-adjusted warped image frame matched in dimension, and output the current output image frame by inputting the concatenated image into the neural network model.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram schematically illustrating a supersampling process according to one or more embodiments;

FIG. 2 is a diagram illustrating the relationship between a low-resolution pixel and a high-resolution pixel according to one or more embodiments;

FIG. 3 is a diagram exemplarily illustrating jittered sampling for a low-resolution pixel area of a three-dimensional (3D) scene and subpixels of a two-dimensional (2D) image frame according to one or more embodiments;

FIG. 4 is a diagram illustrating a method of generating a low-resolution current image frame by jittered sampling according to one or more embodiments;

FIG. 5 is a diagram exemplarily illustrating sampling positions using subpixels of an image frame according to one or more embodiments;

FIGS. 6A and 6B are diagrams illustrating a method of obtaining an adjusted jitter offset for position adjustment of a warped image frame according to embodiments;

FIG. 7 is a diagram illustrating a method of adjusting the position of a warped image frame according to one or more embodiments;

FIG. 8 is a diagram illustrating a supersampling process according to one or more embodiments;

FIG. 9 is a diagram illustrating a supersampling process according to one or more embodiments;

FIG. 10 is a flowchart illustrating a supersampling method according to one or more embodiments;

FIG. 11 is a flowchart illustrating a supersampling process according to one or more embodiments; and

FIG. 12 is a diagram exemplarily illustrating a configuration of an electronic device according to one or more embodiments.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

In the present disclosure, the terms “low” and “high” may be used as relative terms, meaning that a low-resolution pixel has a lower resolution than a high-resolution pixel, and a low-resolution image has a lower resolution than a high-resolution image.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The embodiments described below may be used, for example, in a content providing device for providing image content, a video broadcasting device, a terminal device for transmitting images in a video call or video conference, a game device, and a mobile application processor (AP).

Hereinafter, embodiments will be described in detail with reference to the accompanying drawings. When describing the embodiments with reference to the accompanying drawings, like reference numerals refer to like components, and any repeated description related thereto will be omitted.

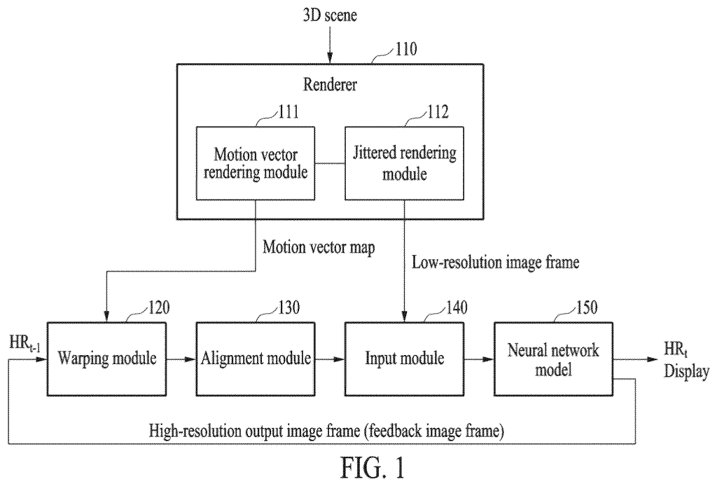

FIG. 1 is a diagram illustrating a supersampling process according to one or more embodiments. Referring to FIG. 1, an electronic device may include a renderer 110, a warping module 120, an alignment module 130, an input module 140, and a neural network model 150 according to one or more embodiments.

The renderer 110 may generate various two-dimensional (2D) rendered images from an input three-dimensional (3D) scene. The various 2D rendered images may include, for example, red, green, and blue (RGB) images, normal maps, depth maps, and motion vector maps, but are not necessarily limited thereto. Hereinafter, for ease of description, a 2D rendered image may be simply referred to as a “2D image” or a “2D image frame”. A 2D image may be a video including a plurality of image frames. A 2D rendered image frame of the current time point may be called the “current image frame”, and a 2D rendered image frame of the previous time point before the current time point may be called the “previous image frame”. The current image frame may include a motion vector map and a jittered sampled image frame, which are generated by rendering an input image that represents the 3D scene.

The renderer 110 may use, for example, subpixel rendering. Subpixel rendering may change sampling points when rendering a low-resolution image by sampling a pixel area of the low-resolution image using a predetermined camera jitter (or a predetermined jitter offset).

Alternatively, the renderer 110 may use a periodic rendering method of uniformly dividing a pixel area of a low-resolution image into smaller subpixel areas corresponding to a high-resolution image. This method may be then used to upscale the high-resolution image and perform sampling periodically in turn by adjusting a sampling position to a corresponding area (e.g., the uniformly divided subpixel area). In this case, a jitter offset value may be fixed to one value.

The renderer 110 may include a motion vector rendering module 111 and a jittered rendering module 112.

When generating various 2D images from a 3D scene input into the renderer 110, the motion vector rendering module 111 may generate a motion vector or motion vector map of a low-resolution size. The motion vector map may correspond to a vector map indicating which pixel in the current image frame matches which pixel in the previous image frame.

The motion vector rendering module 111 may generate a motion vector representing a change between rendered image frames over time. A motion vector may correspond to the difference between the current image frame and the previous image frame. The motion vector may be understood as including a motion vector map. The motion vector rendering module 111 may generate a motion vector so that the effect of jittered sampling may be excluded.

The motion vector rendering module 111 may upscale the motion vector according to the resolution of a previous output image frame. For example, the motion vector rendering module 111 may upscale the motion vector (or the motion vector map) corresponding to the difference between the current image frame and the previous image frame according to the resolution of the previous output image frame. Here, the “previous output image frame” may be an output image frame output from the neural network model 150 and fed back to the warping module 120 as a feedback image frame. Additionally, the “current output image frame” may be an output image frame output from the neural network model 150.

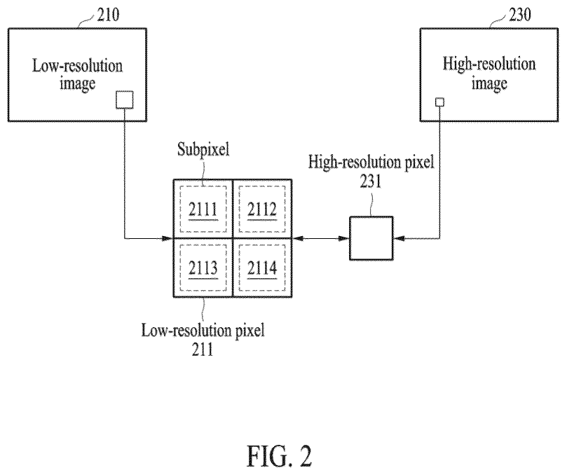

The jittered rendering module 112 may generate a 2D current image frame by performing jittered sampling on the 3D scene based on subpixels of a low-resolution pixel of a 2D image frame. Here, a “low-resolution pixel” may be a pixel of a low-resolution image, and a “high-resolution pixel” may be a pixel of a high-resolution image. A low-resolution pixel may be divided into a plurality of subpixels to have a size corresponding to a high-resolution pixel. The relationship between a low-resolution pixel and a high-resolution pixel will be described in more detail with reference to FIG. 2 below.

In addition, when generating various 2D images from a 3D scene input into the renderer 110, the jittered rendering module 112 may generate a low-resolution image through jittered sampling. Jittered sampling may be obtaining pixel information by slightly misaligning the position of an object to be rendered in an image by finely adjusting the position of a camera through a camera jitter when rendering. The input value of a low-resolution image to which jittered sampling is applied may be shaken (or changed) depending on the jitter offset. In this case, if only jittered sampling is applied, the positional relationship between the shaking of the current low-resolution image frame and the output image frame may not be properly identified, and the supersampling result may be blurred or flickering.

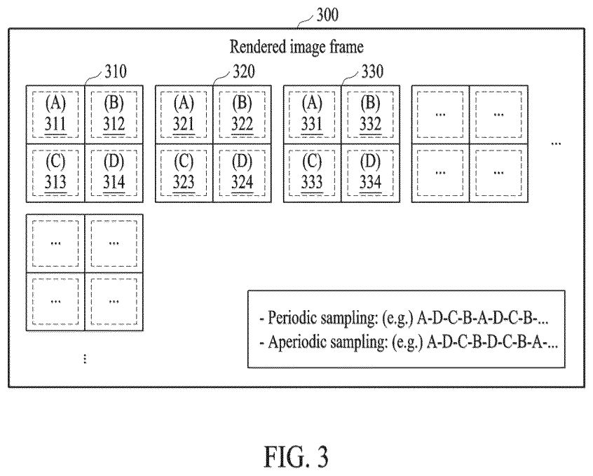

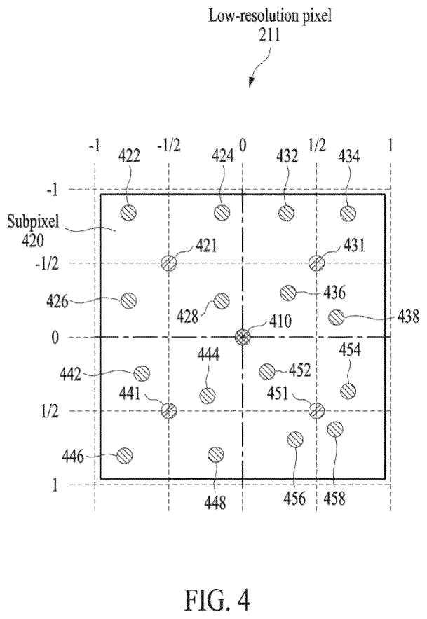

The jittered rendering module 112 may generate a low-resolution current image frame by performing jittered sampling on a low-resolution pixel area of the 3D scene. The jittered rendering module 112 may generate a low-resolution image by performing jittered sampling by a predetermined jitter offset (a “first jitter offset”), for example, as shown in FIG. 4, for the low-resolution pixel area. The jittered rendering module 112 may render a low-resolution image frame by the predetermined jitter offset, calculate the position of the corresponding jitter offset, and then move (e.g., shift) a pixel of a previous warped image frame corresponding to the low-resolution image frame moved to the position of the calculated jitter offset. Jittered sampling will be described in more detail with reference to FIGS. 3 and 4 below.

According to one or more embodiments, the jittered rendering module 112 may perform rendering on the low-resolution image frame for the center of a subpixel only and move (e.g., shift) the pixel of the previous warped image frame. In this case, jittered sampling may be a sampling method that selectively samples sampling points of a 3D scene corresponding to subpixels of each low-resolution pixel. For example, according to jittered sampling, a sampling point of the 3D scene corresponding to a first subpixel of a first low-resolution pixel may be sampled at a first time point, and a sampling point of the 3D scene corresponding to a second subpixel of the first low-resolution pixel may be sampled at a second time point. For example, selective sampling may include periodic sampling, aperiodic sampling, and random sampling.

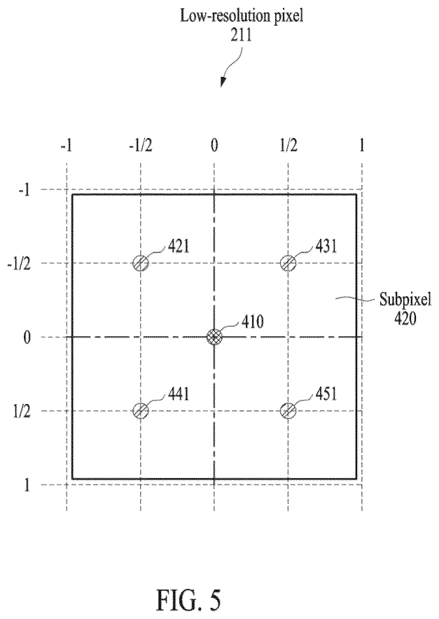

In one or more embodiments, the sampling points may be sampled alternately and periodically based on a predetermined period. The periodic sampling method will be described in more detail with reference to FIG. 5 below.

The warping module 120 may generate a high-resolution warped image frame by warping the previous output image frame of the neural network model 150 based on the motion vector or motion vector map output from the motion vector rendering module 111.

The warping module 120 may perform warping by applying the motion vector map generated by the motion vector rendering module 111 to the high-resolution previous output image frame output from the neural network model 150. The warping module 120 may output a warped high-resolution previous output image frame.

The warping module 120 may perform warping using a method corresponding to the type of motion vector map received from the motion vector rendering module 111. The warping module 120 may perform backward warping or forward warping depending on the type of motion vector map. “Backward warping” may be the process of obtaining a corresponding brightness value by calculating the coordinates in the original image for each position in a result image. At this time, the motion vector map may be a vector field that represents the movement between two image frames, and may indicate where each pixel moves to in the previous frame. Backward warping may find the corresponding position in the previous image frame for each pixel of the current image frame and copy the pixel value thereof. “Forward warping” may be the process of moving each pixel of the original image to a new position in a converted result image. Forward warping may move each pixel of the original image to a new position using a conversion matrix. Forward warping may move (or convert) the coordinates (x, y) of a pixel in the original image to the coordinates (x″, y″) of a pixel in a new result image.

In response to warping using the motion vector or motion vector map, the output image frame may have information corresponding to the next time point (e.g., the current time point). For example, when the electronic device warps the previous output image frame of the neural network model 150 based on the motion vector corresponding to the difference between the current image frame and the previous image frame, the warped previous output image frame may have information corresponding to the current time point.

Due to jittered sampling by the jittered rendering module 112, the position of a pixel in the low-resolution image frame may change. Accordingly, the electronic device may perform supersampling to correspond to the position of the pixel of the low-resolution image frame, or train a neural network of the neural network model 150 to correspond to the position of the pixel of the low-resolution image frame.

The alignment module 130 may be a component for correcting a change in the position of a pixel resulting from jittered sampling. For example, when an alignment method is used for an output image frame corresponding to a low-resolution image frame to which jittered sampling is applied, the position of a pixel in the warped high-resolution previous output image frame in the input data of the neural network model 150 may be adjusted. At this time, the image of the corresponding portion of the previous output image frame where the position of the pixel is adjusted may be shaken according to the adjusted jitter offset.

The alignment module 130 may adjust the position of the warped image frame based on a sampling position change according to jittered sampling. The alignment module 130 may adjust the positions of pixels of the warped image frame so that the area of the pixels of the warped image frame may correspond to the current image frame.

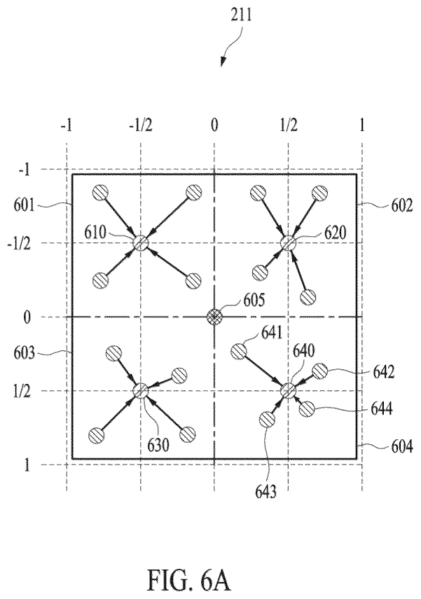

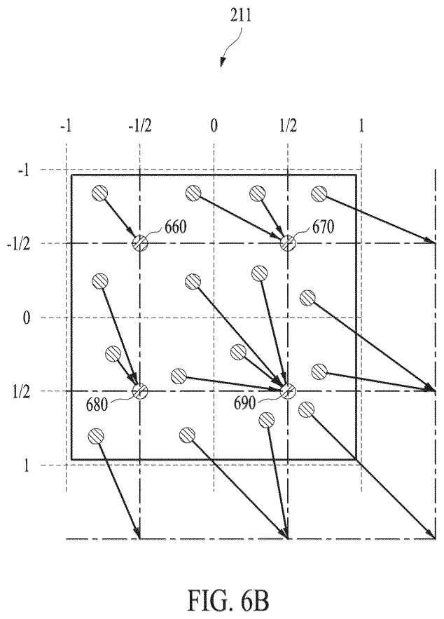

As described above, the alignment module 130 may adjust the positions so that the low-resolution image frame to which jittered sampling is applied may correspond to the pixel area (or subpixel area) of the warped previous output image frame corresponding thereto, and transmit the low-resolution image frame to the input module 140. The alignment method of the alignment module 130 will be described in more detail with reference to FIGS. 6A and 6B below.

According to one or more embodiments, if a predetermined jitter offset is the center of a subpixel, the alignment module 130 may correct the position of the warped image frame by moving (e.g., shifting) the pixels of the warped image frame based on a sampling position change according to jittered sampling.

For example, the alignment module 130 may generate a shifted image frame by moving (e.g., shifting, flipping, or copying) the pixels of the warped image frame based on the current sampling position according to jittered sampling. The alignment module 130 may generate the shifted image frame by shifting the pixels of the warped image frame according to a shift pattern synchronized to the sampling position change according to jittered sampling. At this time, operations (e.g., shift operations) corresponding to the positions of corresponding subpixels of each of the low-resolution pixels of the rendered image frame (e.g., the current image frame) may exist. When one of the subpixels is selected as a sampling target according to jittered sampling, a shifted image frame may be generated based on a shift operation corresponding to the position of the sampling target among the shift operations.

The alignment module 130 may achieve the same effect of adjusting the positions of the pixels of the warped image frame not only by the shift operation described above, but also by a flip operation.

As described above, the sampling positions of subpixels used to determine pixel values of low-resolution pixels of the rendered low-resolution current image frame may change according to jittered sampling. If the alignment module 130 is absent, the output image frame-based processing result (e.g., the warped image frame) that does not reflect such sampling position changes may be input into the neural network model 150. In this case, the neural network model 150 may improve supersampling performance by learning the sampling position changes described above.

The alignment module 130 according to one or more embodiments may adjust the output image frame-based processing result (e.g., the warped image frame) based on the sampling position changes according to jittered sampling, thereby improving the performance of the neural network model 150 without training.

The input module 140 may be a module configured to generate input data to be applied to the neural network model 150. The input module 140 may concatenate the low-resolution current image frame output from the jittered rendering module 112 and the warped image frame whose position is adjusted by the alignment module 130, and input a concatenated image into the neural network model 150.

The input module 140 may generate input data of the neural network model 150 based on the processing results of the warping module 120 and the alignment module 130 for the output image frame of the neural network model 150 and the current image frame output from the jittered rendering module 112. For example, the input module 140 may generate the input data by concatenating the results of processing the output image frame and the rendered image frame. At this time, a space-to-depth conversion may be performed on the position-adjusted warped image frame to match the position-adjusted warped image frame and the current image frame in dimension.

The input module 140 may perform the space-to-depth conversion, for example, using a space-to-depth operation. Here, the “space-to-depth operation” may be a method of changing the data shape by changing the position of a high-resolution image to a depth (or channel) and dividing the high-resolution image into low-resolution image sets, the number of which corresponds to the square of an upscaling scale. For example, if the size of the low-resolution current image frame LR(t) is H (height)×W (width or length)×C (channel), the input size of the neural network model 150 may be H×W×C⋅(scale ratio*scale ratio+1). Here, the scale ratio denotes the upscale ratio of supersampling and may be, for example, “2” times.

The input module 140 may match in dimension by performing the space-to-depth operation for the output (e.g., the position-adjusted warped image frame) of the alignment module 130, and then input the concatenated image acquired by concatenation with the low-resolution current image frame generated by the jittered rendering module 112 into the neural network model 150.

The input module 140 may input an image acquired by concatenating the current image frame and the space-depth conversion result as input data for the neural network model 150. At this time, the processing result according to the space-depth conversion may be divided into pixel sets each corresponding to a low-resolution image, and the input data may be generated by concatenating the current image frame and the pixel sets. The space-to-depth conversion may convert data into a structure suitable for parallel processing.

The neural network model 150 may train the neural network and/or perform inference using the image (e.g., the concatenated image) output from the input module 140 as input. The neural network model 150 may output a high-resolution output image frame. The high-resolution output image frame output from the neural network model 150 may be recursively fed back to the warping module 120 and used again. The neural network model 150 may correspond to a neural supersampling model, and may achieve upscaling and anti-aliasing through supersampling. “Upscaling” may be an image processing technology for increasing the resolution, and may also be called “super resolution”. “Aliasing” may be a phenomenon in which the result is distorted, unlike the continuous form of the original signal, when a signal is reconstructed from samples.

The neural network model 150 may generate the output image frame by performing supersampling on the input data. For example, the neural network model 150 may generate the next output image frame based on the input data including the results of processing the current image frame and the previous output image frame.

The neural network model 150 may include a neural network. The neural network model 150 may be pre-trained to generate high-resolution supersampling results from low-resolution input images. The neural network may include a deep neural network (DNN) including a plurality of layers. The DNN may include at least one of a fully connected network (FCN), a convolutional neural network (CNN), and a recurrent neural network (RNN). For example, at least a portion of the plurality of layers in the neural network may correspond to a CNN, and another portion thereof may correspond to an FCN. The CNN may be referred to as convolutional layers, and the FCN may be referred to as fully connected layers.

The neural network may be trained based on deep learning to perform inference suitable for the purpose of training by mapping input data and output data that are in a non-linear relationship. Deep learning is a machine learning technique for solving a problem such as image recognition or speech recognition from a big data set. Deep learning may be construed as an optimization problem solving process of finding a point at which energy is minimized while training a neural network using prepared training data. Through supervised or unsupervised learning of deep learning, a structure of the neural network or a weight corresponding to a model may be obtained, and the input data and the output data may be mapped to each other through the weight. If the width and the depth of the neural network are sufficiently great, the neural network may have a capacity sufficient to implement a predetermined function. The neural network may achieve an optimized performance when learning a sufficiently large amount of training data through an appropriate training process.

The electronic device may concatenate the low-resolution current image frame on which jittered sampling is performed and the output of the previous time point (the “previous output image frame”) of the neural network model 150 to which the alignment method is applied or additionally concatenate another input (e.g., a feature map or G-buffer information) to the result of concatenating the low-resolution current image frame on which jittered sampling is performed and the output of the previous time point (the “previous output image frame”), and use the concatenation result as the final input of the neural network model 150.

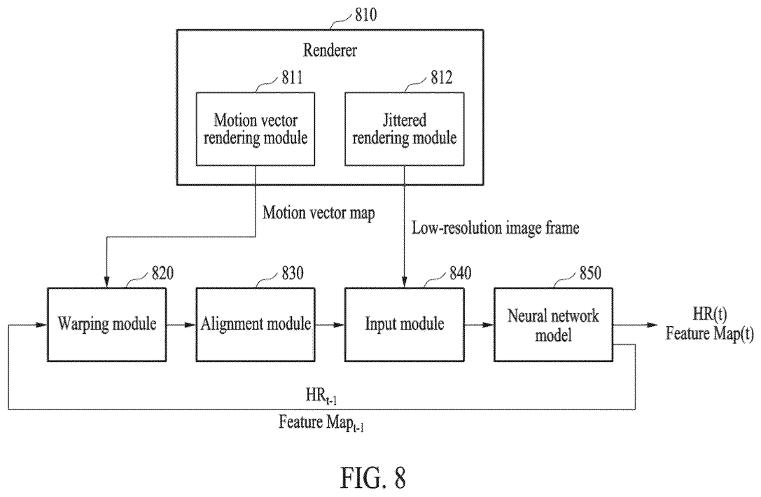

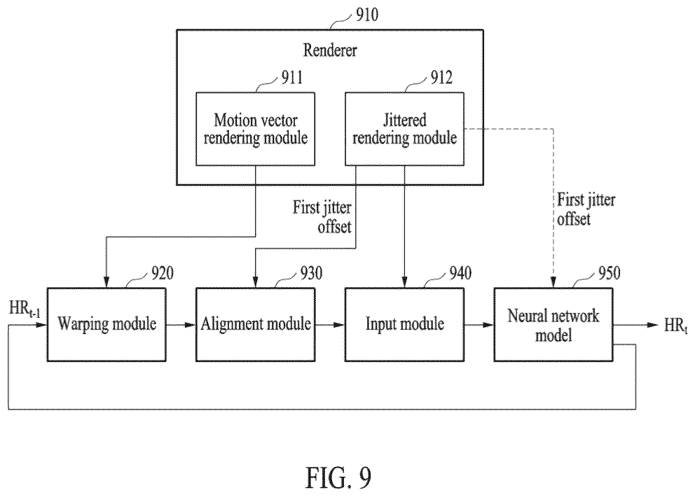

According to one or more embodiments, low-resolution G-buffer information (e.g., the motion vector, depth information, or Albedo color) corresponding to the current image frame may be used additionally as input for the neural network model 150. Additionally, features and/or jitter offsets corresponding to the previous output image frame of the neural network model 150 may be additionally input into the neural network model 150. One or more embodiments in which features and/or jitter offsets corresponding to the previous output image frame are additionally input will be described in more detail with reference to FIGS. 8 and 9 below.

In one or more embodiments, the input/output structure of the neural network model 150 may be defined as a frame-recurrent structure in which an image frame output from the neural network model 150 is recursively provided as input. In the neural network model 150 having a frame-recurrent structure, an image frame having the same size as the output image frame may be used again as the current input. The frame-recurrent structure may recurrently accumulate samples over multiple image frames. At this time, if a low-resolution image is sampled only in one pixel area, it may be difficult to accumulate diverse information. For example, for an object and a camera being stationary, the same value may be obtained if samples are accumulated over multiple frames but sampling is performed only in one pixel area. In contrast, jittered sampling may accumulate more samples over the entire frame corresponding to a high-resolution area and thus, may be more suitable for a frame-recurrent structure than the method of sampling only in one pixel area.

In one or more embodiments, the image restoration capability may be improved by concatenating the pixel area of the low-resolution current image frame acquired through jittered sampling and the output of the previous time point (the “previous output image frame”) to which the alignment method is applied and inputting the concatenation result into the neural network model 150. Additionally, in one or more embodiments, the limitations of applying the neural supersampling method for mobiles due to a large amount of computation may be overcome through subpixel rendering and/or alignment.

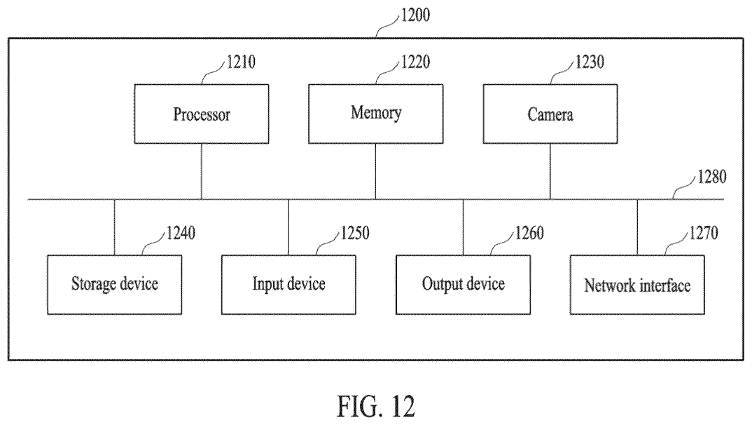

The renderer 110, the motion vector rendering module 111, the jittered rendering module 112, the warping module 120, the alignment module 130, and the input module 140 may be implemented by hardware modules and/or software modules. According to one or more embodiments, the electronic device (e.g., the electronic device 1200 of FIG. 12 and/or a processor (e.g., the processor 1210 of FIG. 12) of the electronic device) may perform supersampling operations using the renderer 110, the motion vector rendering module 111, the jittered rendering module 112, the warping module 120, the alignment module 130, the input module 140, and the neural network model 150 according to embodiments. The operations of the renderer 110, the motion vector rendering module 111, the jittered rendering module 112, the warping module 120, the alignment module 130, and the input module 140 may be described as the operations of the electronic device and/or the processor of the electronic device.

FIG. 2 is a diagram illustrating the relationship between a low-resolution pixel and a high-resolution pixel according to one or more embodiments. Referring to FIG. 2, a low-resolution pixel 211 of a low-resolution image 210 according to one or more embodiments may include subpixels 2111 to 2114. The size of the subpixels 2111 to 2114 may correspond to the size of a high-resolution pixel 231 of a high-resolution image 230. The ratio of lengths in the horizontal or vertical direction may be defined as a scaling factor. The scaling factor of FIG. 2 may be “2”.

The size ratio of the area of the low-resolution pixel 211 to the area of the high-resolution pixel 231 may be proportional to the square of the scaling factor. If the scaling factor is “2”, the size ratio of the area of the low-resolution pixel 211 to the area of the high-resolution pixel 231 may be “4”.

For example, a 3D scene may be projected onto the low-resolution image 210 during the rendering process by a jittered rendering module (e.g., the jittered rendering module 112 of FIG. 1). At this time, points in the 3D scene may be projected onto low-resolution pixels (e.g., the low-resolution pixel 211) of the low-resolution image 210. The points in the 3D scene that are projected onto low-resolution pixels may be called “sampling points”.

In selecting sampling points, an electronic device may use sampling points based on a predetermined jitter offset in the subpixels 2111 to 2114 rather than the center of the low-resolution pixel 211 or use the centers of the subpixels 2111 to 2114 rather than the center of the low-resolution pixel 211.

The sampling points (e.g., arbitrary points or the center points) in the subpixels 2111 to 2114 may be optionally used according to jittered sampling. For example, a sampling point of the 3D scene corresponding to the subpixel 2111 may be sampled when generating a first rendered image frame, a sampling point of the 3D scene corresponding to the subpixel 2112 may be sampled when generating a second rendered image frame after the first rendered image frame, and a sampling point of the 3D scene corresponding to the subpixel 2113 may be sampled when generating a third rendered image frame after the second rendered image frame. As described above, jittered sampling that varies sampling points in relation to the same low-resolution pixel 211 may be performed.

FIG. 3 is a diagram exemplarily illustrating jittered sampling for a low-resolution pixel area of a three-dimensional (3D) scene and subpixels of a two-dimensional (2D) image frame according to one or more embodiments. Referring to FIG. 3, according to one or more embodiments, a rendered current image frame 300 may include low-resolution pixels 310, 320, and 330. The low-resolution pixel 310 may include subpixels 311, 312, 313, and 314, the low-resolution pixel 320 may include subpixels 321, 322, 323, and 324, and the low-resolution pixel 330 may include subpixels 331, 332, 333, and 334.

Subpixel(s) belonging to an arbitrary low-resolution pixel area may be called “corresponding subpixel(s)”. For example, the subpixels 311, 312, 313, and 314 may be called corresponding subpixels of the low-resolution pixel 310, the subpixels 321, 322, 323, and 324 may be called corresponding subpixels of the low-resolution pixel 320, and the subpixels 331, 332, 333, and 334 may be called corresponding subpixels of the low-resolution pixel 330.

A single low-resolution pixel may include subpixels, the number of which corresponds to the resolution ratio between a high-resolution image and a low-resolution image (e.g., “4” times). The resolution ratio may be the square of a scaling factor.

The subpixels 311, 312, 313, 314, 321, 322, 323, 324, 331, 332, 333, and 334 may be distinguished by position. For example, the subpixels 311, 312, 313, 314, 321, 322, 323, 324, 331, 332, 333, and 334 may be divided as positions A, B, C, and D as shown in FIG. 3. As the sampling position changes according to jittered sampling, subpixels at the corresponding position may be sampled.

In one or more embodiments, sampling points may be sampled alternately based on a predetermined period according to jittered sampling. For example, jittered sampling may be performed in the order of the subpixels 311, 321, and 331 at position A, the subpixels 314, 324, and 334 at position D, the subpixels 313, 323, and 333 at position C, the subpixels 312, 322, and 332 at position B, the subpixels 311, 321, and 331 at position A, the subpixels 314, 324, and 334 at position D, the subpixels 313, 323, and 333 at position C, and the subpixels 312, 322, and 332 at position B.

Alternatively, depending on the embodiment, sampling points may be sampled aperiodically according to a predetermined jitter offset in the low-resolution pixel area. Non-periodic sampling may be a method of arbitrarily selecting an area of subpixel(s) and selecting an arbitrary jitter offset within the selected arbitrary subpixel(s).

For example, jittered sampling may be performed in the order of the subpixels 311, 321, and 331 at position A, the subpixels 314, 324, and 334 at position D, the subpixels 313, 323, and 333 at position C, the subpixels 312, 322, and 332 at position B, the subpixels 314, 324, and 334 at position D, the subpixels 313, 323, and 333 at position C, the subpixels 312, 322, and 332 at position B, and the subpixels 311, 321, and 331 at position A.

Sampling positions according to periodic sampling may be determined based on frame progression. For example, a frame progression such as i=0, 1, 2, . . . may occur, where i denotes the frame number. In this case, positions A to D may be assigned to a frame where i%4 ==0 to a frame where t%4==3, respectively. Here, the frame number may be divided by “4”, which is the numeral indicating the number of subpixels belonging to each low-resolution pixel. The numeral may indicate the resolution ratio of a low-resolution image and a high-resolution image. For example, position A may be assigned to the frame where i%4 ==0, position D may be assigned to a frame where i%4 ==1, position C may be assigned to a frame where i%4 ==2, and position B may be assigned to a frame where i%4 ==3. In this case, sampling of the subpixels 311, 321, and 331 at position A in the frame where i=0, the subpixels 314, 324, and 334 at position D in the frame where i=1, the subpixels 313, 323, and 333 at position C in the frame where i=2, the subpixels 312, 322, and 332 at position B in the frame where i=3, the subpixels 311, 321, and 331 at position A in the frame where i=4, and the subpixels 314, 324, and 334 at position D in the frame where i=5 may be performed.

FIG. 4 is a diagram illustrating a method of generating a low-resolution current image frame by jittered sampling according to one or more embodiments.

Referring to FIG. 4, a diagram showing candidate points 422, 424, 426, 428, 432, 434, 436, 438, 442, 444, 446, 448, 452, 454, 456, and 458 on which jittered sampling is performed in an area of the low-resolution pixel 211 by a jittered rendering module (e.g., the jittered rendering module 112 of FIG. 1) according to one or more embodiments is shown. The sampling candidate points 422, 424, 426, 428, 432, 434, 436, 438, 442, 444, 446, 448, 452, 454, 456, and 458 may correspond to respective arbitrary points of sixteen subpixels 420 included in the area of the low-resolution pixel 211.

As described above, the jittered rendering module (e.g., the jittered rendering module 112 of FIG. 1) may generate a low-resolution image (image frame) through jittered sampling, when a renderer (e.g., the renderer 110 of FIG. 1) generates various 2D images from an input 3D scene. The jittered rendering module may perform, for example, subpixel jittered sampling. Subpixel jittered sampling is a method of performing sampling while changing the position of a pixel (or subpixel) to be sampled by applying a camera jitter when sampling to generate a low-resolution image. Here, a jitter offset may be arbitrarily determined in a low-resolution pixel area. The jitter offset may be the difference coordinates of four pixels included in the low-resolution pixel area from arbitrary reference points 421, 431, 441, and 451. At this time, the arbitrary reference points 421, 431, 441, and 451 may be equidistant from the center point 410 of the low-resolution pixel 211. The jittered rendering module may transmit the jitter offset value to the outside (e.g., a neural network model or the outside of the electronic device).

FIG. 5 is a diagram exemplarily illustrating sampling positions using subpixels of an image frame according to one or more embodiments.

Referring to FIG. 5, the jittered rendering module 112 according to one or more embodiments may periodically render a low-resolution current image frame if a jitter offset of the low-resolution current image frame exactly matches the center point of a high-resolution subpixel.

The low-resolution pixel 211 may include subpixels (e.g., subpixels 420). According to jittered sampling, instead of the center point 410 of the low-resolution pixel, the centers of the subpixels may be used as sampling points, that is, reference points 421, 431, 441, and 451.

The periodic rendering method shown in FIG. 5 may correspond to an example of the jittered rendering module 112 shown in FIG. 4.

The size of one low-resolution pixel area may be proportional to the square of a scale compared to the size of one high-resolution pixel area. If multiple low-resolution pixel areas divided as one high-resolution pixel area are called low-resolution subpixel areas, an electronic device may sample one subpixel area once for each period t1.

The electronic device samples one subpixel area for each period t1 and thus, may sample all positions of high-resolution subpixels in one period.

The effect of such a periodic structure is to avoid sampling only at low-resolution sampling points when the camera is stationary or moves constantly only in a predetermined direction, by sampling all positions of high-resolution subpixels, and to obtain a finer image sampling value of a high-resolution area. For example, assuming all objects are stationary for a period t1 and the camera is also stationary, the electronic device may acquire a high-resolution image of the original for every period t1.

FIGS. 6A and 6B are diagrams illustrating a method of obtaining an adjusted jitter offset for position adjustment of a warped image frame according to embodiments.

Referring to FIG. 6A, a method of obtaining a jitter offset by an alignment module (e.g., the alignment module 130 of FIG. 1) according to one or more embodiments is shown.

An electronic device may divide the positions of pixels of the current image frame as high-resolution pixel areas. The electronic device may obtain an adjusted jitter offset value (the “second jitter offset value”) so that the positions of the pixels of the current image frame are included in the high-resolution pixel areas. At this time, the second jitter offset value may correspond to a sampling position adjusted so that the positions of the pixels of the current image frame are included in the high-resolution pixel areas.

The method of obtaining an adjusted jitter offset value (e.g., the second jitter offset value) by the electronic device is as follows.

For example, if the position of the sampled pixel in the current image frame corresponds to an area (x:-1 to 0, y:-1 to 0) of the high-resolution pixel area, the electronic device may assign the sampled pixel to a first quadrant 601 of the high-resolution pixel area. If the position of the sampled pixel corresponds to an area (x: 0 to 1, y:-1 to 0) of the high-resolution pixel area, the electronic device may assign the sampled pixel to a second quadrant 602 of the high-resolution pixel area. If the position of the sampled pixel corresponds to an area (x: −1 to 0, y: 0 to 1) of the high-resolution pixel area, the electronic device may assign the sampled pixel to a third quadrant 603 of the high-resolution pixel area. If the position of the sampled pixel in the current image frame corresponds to an area (x: 0 to 1, y: 0 to 1) of the high-resolution pixel area, the electronic device may assign the sampled pixel to a fourth quadrant 604 of the high-resolution pixel area.

At this time, the boundary lines dividing the quadrants may be determined based on a (0,0) point 605 of the high-resolution pixel area as shown in FIG. 6A, or may be determined based on a (−½, −½) point 660, a (½, −½) point 670, a (−½, ½) point 680, and a (½, ½) point 690 of the high-resolution pixel area as shown in FIG. 6B.

The electronic device may obtain the second jitter offset value based on the distance from the position of the sampled pixel, assigned to each quadrant, to the reference point 610, 620, 630, or 640. The electronic device may obtain, for example, the second jitter offset value based on the distance from a pixel (e.g., a pixel 641, 642, 643, or 644) assigned to the fourth quadrant 604 to the reference point 640.

The electronic device may adjust the position based on the adjusted jitter offset (e.g., the second jitter offset value) using the method described above so that the high-resolution warped image frame may correspond to the low-resolution current image frame. The electronic device may adjust the position of the warped image frame based on the second jitter offset value. The electronic device may adjust the position of the warped image frame so that the warped image frame matches the same area as the current image frame whose position is adjusted based on the second jitter offset value.

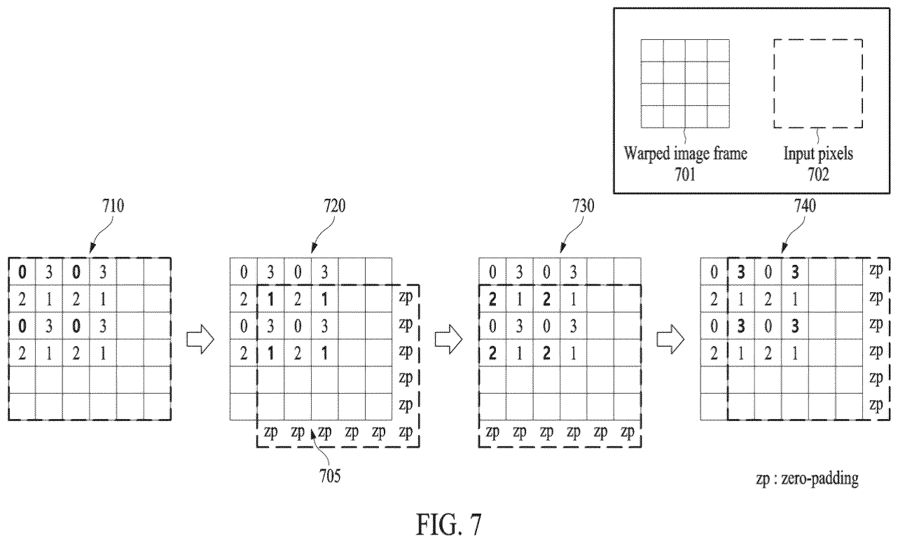

The electronic device may adjust the position of the warped image frame by, for example, placing the warped image frame in the same area as the current image frame whose position is adjusted based on the second jitter offset value, by zero-padding and cropping the warped image frame shown in FIG. 7. In adjusting the position of the warped image frame, the electronic device may place the warped image frame in the same area as the position of the adjusted jitter offset of the low-resolution current image frame by zero-padding and cropping the high-resolution warped image frame. In cropping the warped image frame, the electronic device may crop two subpixel areas or three or more subpixel areas, rather than one subpixel area.

As another example, the electronic device may adjust the position of the warped image frame by placing the warped image frame in the same area as the current image frame whose position is adjusted based on the second jitter offset value through flipping that reverses the warped image frame. The electronic device may place the warped image frame in the same area as the current image frame by moving (e.g., shifting) the position of the warped image frame forth, back, left, and right or by flipping the warped image frame left and right, up and down, or up, down, left, and right.

Additionally, the electronic device may adjust the position of the warped image frame by placing the warped image frame in the same area as the current image frame whose position is adjusted based on the second jitter offset value through reflection of the surrounding values of the warped image frame.

The alignment module according to one or more embodiments may always enable the adjusted jitter offset position of the low-resolution current input image frame to be placed at the same position as the position of the high-resolution warped image frame corresponding thereto through the various methods described above.

FIG. 7 is a diagram illustrating a method of adjusting the position of a warped image frame according to one or more embodiments. Referring to FIG. 7, a high-resolution warped image frame 701 and input pixels 702 of a low-resolution current image frame according to one or more embodiments are shown.

The electronic device may zero-pad and crop the high-resolution warped image frame 701 and move the warped image frame 701 to be matched to the input pixels 702 in the same area as the adjusted jitter offset position of the low-resolution current image frame. At this time, the input pixels 702 may be sampled in the matched warped image frame 701.

In a first example 710, the electronic device may match the positions of input pixels 702 of the low-resolution image frame marked in bold “0 ” and the corresponding positions of the high-resolution image frame 701 to always be at (0,0).

In a second example 720, the electronic device may match the positions of input pixels 702 of the low-resolution image frame marked in bold “1” and the corresponding positions of the high-resolution image frame 701 to always be at (0,0). At this time, a blank area 705 may be generated due to movement for alignment. Pixel values in the blank area 705 may be filled with zero (“0”) according to zero padding, filled with adjacent values by reflection or flipping, or filled according to extrapolation. However, the method of processing the blank area 705 is not limited thereto.

The electronic device may zero-pad one pixel from each of the right and the bottom of the high-resolution warped image frame 701 and crop one pixel from each of the top and the left. At this time, the electronic device may crop two pixels, or three or more pixels, rather than one pixel, so that the positions of the input pixels 702 of the current image frame and the corresponding positions of the warped image frame 701 are always placed at (0,0).

In a third example 730, the electronic device may match the positions of input pixels 702 of the low-resolution image frame marked in bold “2” and the corresponding positions of the high-resolution image frame 701 to always be at (0,0).

Further, in a fourth example 740, the electronic device may match the positions of input pixels 702 of the low-resolution image frame marked in bold “3” and the corresponding positions of the high-resolution image frame 701 to always be at (0,0).

The electronic device may match the positions of the input pixels 702 of the current image frame and the corresponding positions of the warped image frame 701 by a reflection method that copies surrounding values rather than zero-padding described above.

The electronic device may match the positions not by moving the warped image frame back and forth and left and right, but by flipping the warped image frame left and right, up and down, or up, down, left, and right.

For example, high-resolution pixels of the warped image frame 701 may be divided as positions A to D as described above with reference to FIG. 3, like subpixels of a low-resolution pixel. Unlike the case where corresponding subpixels of a single low-resolution pixel are divided as positions A to D, a plurality of high-resolution pixels corresponding to the corresponding subpixels may be divided as positions A to D. Reference values of “0” to “3” may be assigned to positions A to D. As with jittered sampling, the reference values of “0” to “3” may be the remainder of the frame number I divided by the number of corresponding subpixels belonging to one low-resolution pixel, that is, by the resolution ratio between a low-resolution image (e.g., the rendered image frame) and a high-resolution image (e.g., the output image frame).

According to jittered sampling, the positions at which the input pixels 702 are extracted from the warped image frame 701 may be determined based on the positions of the subpixels used for sampling. For example, the positions at which the input pixels 702 are extracted from the warped image frame 701 may be determined based on the remainder of the frame number i divided by the resolution rate.

FIG. 8 is a diagram illustrating a supersampling process according to one or more embodiments. Referring to FIG. 8, an electronic device including a renderer 810, a warping module 820, an alignment module 830, an input module 840, and a neural network model 850 according to one or more embodiments is shown.

The operations of the renderer 810, a motion vector rendering module 811, a jittered rendering module 812, the warping module 820, the alignment module 830, the input module 840, and the neural network model 850 are similar to the operations of the renderer 110, the motion vector rendering module 111, the jittered rendering module 112, the warping module 120, the alignment module 130, the input module 140, and the neural network model 150 shown in FIG. 1. Therefore, the following description will focus on the operations that are different from those of FIG. 1.

According to the embodiment of FIG. 8, the operations of the warping module 820 and the neural network model 850 may differ. The neural network model 850 may output a current output image frame HR(t) and a feature map Feature Map(t) corresponding to the current output image frame. The feature map may be used recursively as input to the neural network model 850. The feature map may be the same size as the low-resolution image or the high-resolution image. The feature map may have multiple channels in the corresponding size.

The electronic device may feed back the current output image frame and the feature map from the neural network model 850 to the warping module 820. The fed-back feature map may be used as input to the neural network model 850 along with the current output image frame.

The warping module 820 may warp the previous output image frame by applying a motion vector to the previous output image frame HR(t−1), which is the output image frame output from the neural network model 850, and the feature map Feature Map(t−1). At this time, the feature map warped by the warping module 820 may be used as additional input to the alignment module 830 or may be concatenated by the input module 840.

FIG. 9 is a diagram illustrating a supersampling process according to one or more embodiments. Referring to FIG. 9, an electronic device including a renderer 910, a warping module 920, an alignment module 930, an input module 940, and a neural network model 950 according to one or more embodiments is shown.

The operations of the renderer 910, a motion vector rendering module 911, a jittered rendering module 912, the warping module 920, the alignment module 930, the input module 940, and the neural network model 950 are similar to the operations of the renderer 110, the motion vector rendering module 111, the jittered rendering module 112, the warping module 120, the alignment module 130, the input module 140, and the neural network model 150 shown in FIG. 1. Therefore, the following description will focus on the operations that are different.

The neural network model 950 may receive a first jitter offset as additional input from the jittered rendering module 912 of the renderer 910. The neural network model 950 may perform inference by adding or multiplying a predetermined value corresponding to the first jitter offset to or by the output image frame of the neural network model 950.

The electronic device may convert the first jitter offset into a feature in a vector form using a multilayer perceptron (MLP) or the like and use the feature to train the neural network model 950. The electronic device may add or subtract the feature in a vector form to or from the weight or bias of an arbitrary layer of the neural network model 950 and use the result value to reflect the first jitter offset at the network level.

The neural network model 950 may perform inference by adding or multiplying a predetermined value corresponding to the first jitter offset to or by the kernel weight or bias value of an arbitrary layer in the neural network model 950. The neural network model 950 may apply the predetermined value corresponding to the first jitter offset to the current output image frame. The neural network model 950 may output the current output image frame by applying the predetermined value corresponding to the first jitter offset to the kernel weight or bias values of the layers of the neural network model 950.

Alternatively, the electronic device may add or multiply a predetermined value corresponding to a jitter offset to or by each feature map before or after an activation function of an arbitrary layer.

For example, when the neural network model 950 uses the structure of a kernel prediction network, the electronic device may add or subtract the feature in a vector form to or from the filter weight in filtering and use the result value to reflect the first jitter offset. The electronic device may output the current output image frame by applying the predetermined value corresponding to the first jitter offset to a filter of the kernel prediction network. At this time, the predetermined value corresponding to the first jitter offset may include at least one of the first jitter offset, a formula calculated using the value of the first jitter offset, and a value obtained through separate learning using the first jitter offset value as input.

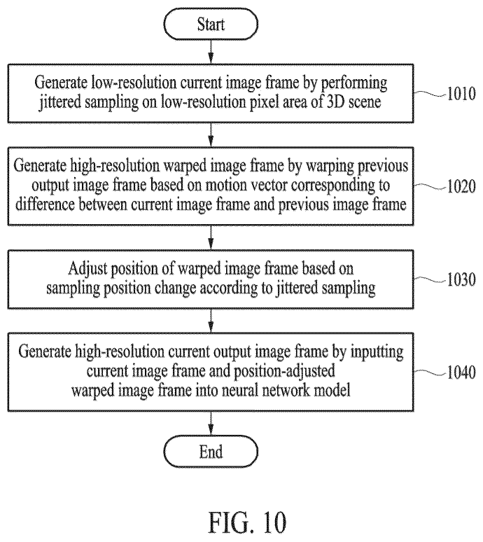

FIG. 10 is a flowchart illustrating a supersampling method according to one or more embodiments. In the following embodiment, operations may be performed sequentially, but are not necessarily performed sequentially. For example, the order of the operations may be changed, and at least two of the operations may be performed in parallel.

Referring to FIG. 10, an electronic device according to one or more embodiments may generate a high-resolution current output image frame through operations 1010 to 1040.

In operation 1010, the electronic device generates a low-resolution current image frame by performing jittered sampling on a low-resolution pixel area of a 3D scene. The electronic device may perform jittered sampling based on a predetermined first jitter offset for the low-resolution pixel area. A “jitter offset” may correspond to the difference coordinates from an arbitrary reference point in the low-resolution pixel area. The electronic device may generate the current image frame by performing jittered sampling on subpixels included in the low-resolution pixel area. According to one or more embodiments, the electronic device may perform jittered sampling by selectively sampling respective sampling points corresponding to the subpixels. At this time, the sampling points may be sampled alternately based on a predetermined period.

In operation 1020, the electronic device generates a high-resolution warped image frame by warping a previous output image frame based on a motion vector corresponding to the difference between the current image frame generated in operation 1010 and a previous image frame. The previous image frame may be the previous output image frame output by a neural network model. The neural network model may output a feature map corresponding to the current output image frame in addition to the current output image frame. In this case, the electronic device may warp the previous output image frame by applying the motion vector to the current output image frame and the feature map. Here, the motion vector may include a motion vector map of a low-resolution size.

In operation 1030, the electronic device adjusts the position of the warped image frame generated in operation 1020, based on a sampling position change according to jittered sampling performed in operation 1010. The electronic device may adjust the position of the previous warped frame to correspond to the current image frame. The electronic device may, for example, adjust the position of the previous warped image frame so that the position (0,0) of the previous warped image frame matches the camera jitter position of the current frame.

The electronic device may adjust the positions of pixels of the warped image frame so that an area of the pixels of the warped image frame corresponds to the current image frame. The electronic device may divide the positions of pixels of the current image frame as high-resolution pixel areas. The electronic device may obtain a second jitter offset value corresponding to a sampling position adjusted so that the positions of the pixels of the current image frame are included in the high-resolution pixel areas. The electronic device may adjust the position of the warped image frame based on the second jitter offset value. The electronic device may adjust the position of the warped image frame so that the warped image frame is matched to the same area as the current image frame whose position is adjusted based on the second jitter offset value. The electronic device may adjust the position of the warped image frame by placing the warped image frame in the same area as the current image frame whose position is adjusted based on the second jitter offset value, for example, by zero-padding and cropping the warped image frame. Alternatively, the electronic device may adjust the position of the warped image frame by placing the warped image frame in the same area as the current image frame whose position is adjusted based on the second jitter offset value, by flipping or reflecting the warped image frame.

In operation 1040, the electronic device generates a high-resolution current output image frame by inputting the current image frame generated in operation 1010 and the warped image frame whose position is adjusted in operation 1030 into a neural network model. The electronic device may match the warped image frame whose position is adjusted in operation 1030 and the current image frame generated in operation 1010 in dimension. The electronic device may match the dimensions by rearranging the position-adjusted warped image frame to correspond to a depth or a channel of the neural network model by a space-to-depth operation. Here, the “space-to-depth operation” may be an operation to rearrange spatial data blocks in depth. The space-to-depth operation may output a copy of an input (or an input tensor) where the values in height and width dimensions are moved to a depth dimension. For example, non-overlapping blocks of the size of block_size x block size may be rearranged in depth at each position. The depth of an output (or an output tensor) may be block_size*block_size*input_depth. At this time, the Y, X coordinates in each block of the input may be higher components of an output channel index.

The electronic device may generate a concatenated image by concatenating the current image frame and the position-adjusted warped image frame matched in dimension. The electronic device may output the current output image frame by inputting the concatenated image into the neural network model.

The neural network model may receive a first jitter offset and apply a predetermined value corresponding to the first jitter offset to the current output image frame. Here, “applying” the predetermined value corresponding to the first jitter offset to the current output image frame may be understood as performing various operations including arithmetic operations such as adding or multiplying the predetermined value corresponding to the first jitter offset to or by the current output image frame. The “predetermined value corresponding to the first jitter offset” may include at least one of the first jitter offset itself, a formula calculated using the value of the first jitter offset, and a value obtained through separate learning using the first jitter offset value as input.

According to one or more embodiments, the neural network model may receive a first jitter offset, and output the current output image frame by applying a predetermined value corresponding to the first jitter offset to the kernel weight or bias values of layers of the neural network model.

In addition, when the neural network model uses the structure of a kernel prediction network, the electronic device may output the current output image frame by applying a predetermined value corresponding to the first jitter offset or a second jitter offset to the weight of a kernel function of the kernel prediction network using arithmetic operations. Here, the “kernel prediction network” may perform prediction on the weight of the kernel function to be performed on given input data. The weight of the kernel function may be predicted pixelwise or depthwise. The kernel function may help solve nonlinear problems linearly by converting data into a high-dimensional space. The kernel function may generate an output by performing pixelwise convolution or arithmetic operations on the input data using the pixelwise weight of the kernel function predicted by the kernel prediction network. Kernel prediction networks are mainly used in image processing, and may be configured as, for example, convolutional neural networks (CNNs). In a CNN, a kernel (or a filter) may be used to extract predetermined features of an image. The kernel may generate a feature map by performing convolution operations or performing pixelwise convolution or arithmetic operations while scanning each part of the image.

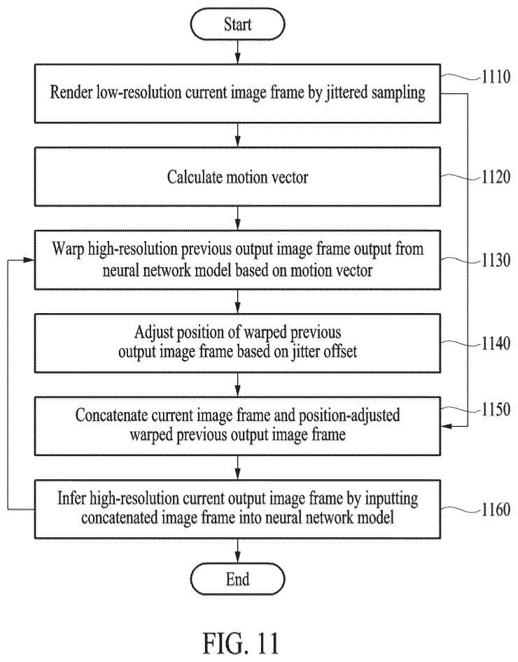

FIG. 11 is a flowchart illustrating a supersampling process according to one or more embodiments. Referring to FIG. 11, an electronic device according to one or more embodiments may infer (generate) a high-resolution current output image frame through operations 1110 to 1160.

In operation 1110, the electronic device may render a low-resolution current image frame by jittered sampling.

In operation 1120, the electronic device may calculate a motion vector corresponding to the difference between the current image frame rendered in operation 1110 and a previous image frame.

In operation 1130, the electronic device may warp a high-resolution previous output image frame output from a neural network model based on the motion vector calculated in operation 1120.

In operation 1140, the electronic device may adjust the position of the previous output image frame warped in operation 1130 (the “warped image frame”) based on a jitter offset. At this time, the jitter offset may correspond to the offset value used for jittered sampling in operation 1110.

In operation 1150, the electronic device may concatenate the current image frame rendered in operation 1110 and the warped previous output image frame whose position is adjusted in operation 1140.

In operation 1160, the electronic device may infer a high-resolution current output image frame by inputting the image frame concatenated in operation 1150 into the neural network model. The inferred current output image frame may be transmitted to operation 1130 and used as the previous output image frame.

FIG. 12 is a diagram exemplarily illustrating a configuration of an electronic device according to one or more embodiments. Referring to FIG. 12, an electronic device 1200 may include a processor 1210, a memory 1220, a camera 1230, a storage device 1240, an input device 1250, an output device 1260, and a network interface 1270 that may communicate with each other through a communication bus 1280.

The electronic device 1200 may be implemented in a personal computer (PC), a cloud server, a data server, or a portable device such as a mobile device. The portable device may be implemented as a laptop computer, a mobile phone, a smart phone, a tablet PC, a mobile internet device (MID), a personal digital assistant (PDA), an enterprise digital assistant (EDA), a digital still camera, a digital video camera, a portable multimedia player (PMP), a personal navigation device (or portable navigation device) (PND), a game console such as a handheld game console, a portable game console or a wearable game console, an e-book, and/or a smart device. The smart device may be implemented as a smart watch, a smart band, smart glasses, and/or a smart ring. Additionally, the electronic device 1200 may be implemented as at least part of a home appliance such as a television, a smart television or a refrigerator, a security device such as a door lock, or a vehicle such as an autonomous vehicle or a smart vehicle.

The processor 1210 executes functions and instructions to be executed in the electronic device 1200. For example, the processor 1210 may process instructions stored in the memory 1220 or the storage device 1240. The processor 1210 may perform at least one method described above with reference to FIGS. 1 to 11 or an algorithm corresponding to the at least one method. The algorithm may be implemented in a pipeline plug-in form using artificial intelligence (AI), such as a neural network model, into a graphics rendering engine. Alternatively, the algorithm may be implemented on a mobile system-on-chip (SoC) equipped with neural processing units (NPUs).

Additionally, the processor 1210 may be a hardware-implemented data processing device having a circuit that is physically structured to execute desired operations. The desired operations may include, for example, code or instructions included in a program. The processor 1210 may be implemented as, for example, a central processing unit (CPU), a graphics processing unit (GPU), or a neural network processing unit (NPU). The processor 1210 may include, for example, a microprocessor, a central processing unit (CPU), a processor core, a multi-core processor, a multiprocessor, an application-specific integrated circuit (ASIC), and a field-programmable gate array (FPGA).

The processor 1210 may execute a program and control the electronic device 1200. Program code to be executed by the processor 1210 may be stored in the memory 1220.

For example, the processor 1210 generates a low-resolution current image frame by performing jittered sampling on a low-resolution pixel area of a 3D scene. The processor 1210 generates a high-resolution warped image frame by warping a previous output image frame based on a motion vector corresponding to the difference between the current image frame and a previous image frame. The processor 1210 adjusts the position of the warped image frame based on a sampling position change according to jittered sampling. The processor 1210 generates a high-resolution current output image frame by inputting the current image frame and the position-adjusted warped image frame into a neural network model.

The memory 1220 may include a computer-readable storage medium or a computer-readable storage device. The memory 1220 may store instructions to be executed by the processor 1210 and may store related information while software and/or an application is executed by the electronic device 1200.

The memory 1220 stores the neural network model. The neural network model may be trained, for example, using unsupervised learning or self-supervised learning. The neural network model may include a deep neural network (DNN), a convolutional neural network (CNN), a recurrent neural network (RNN), a perceptron, a multilayer perceptron, a feedforward (FF) network, a radial basis network (RBF), a deep feedforward (DFF) network, a long short-term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a binarized neural network (BNN), a transformer, and an attention network (AN).

Additionally, the memory 1220 may store instructions (or programs) executable by the processor 1210. For example, the instructions may include instructions for executing the operation of the processor 1210 and/or the operation of each component of the processor 1210.

The memory 1220 may be implemented as a volatile memory device or a non-volatile memory device.

The camera 1230 may capture a photo and/or record a video. The storage device 1240 includes a computer-readable storage medium or computer-readable storage device. The storage device 1240 may store a larger quantity of information than the memory 1220 for a long time. For example, the storage device 1240 may include a magnetic hard disk, an optical disc, a flash memory, a floppy disk, or other non-volatile memories known in the art.

The input device 1250 may receive an input from a user in traditional input manners through a keyboard and a mouse, and in new input manners such as a touch input, a voice input, and an image input. For example, the input device 1250 may include a keyboard, a mouse, a touch screen, a microphone, or any other device that detects the input from the user and transmits the detected input to the electronic device 1200. The output device 1260 may provide an output of the electronic device 1200 to the user through a visual, auditory, or haptic channel. The output device 1260 may include, for example, a display, a touch screen, a speaker, a vibration generator, or any other device that provides the output to the user. For example, the output device 1260 may display output image frames including the previous output image frame and the current output image frame. The network interface 1270 may communicate with an external device through a wired or wireless network.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored permanently or temporarily in any type of machine, component, physical or virtual equipment, computer storage medium, or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and equivalents to the claims are also within the scope of the following claims.

What is claimed is:

1. An image processing method comprising:
generating a current image frame at a first resolution by performing jittered sampling on a first-resolution pixel area of a three-dimensional (3D) scene;
generating a warped image frame at a second resolution higher than the first resolution, by warping a feedback image frame based on a motion vector corresponding to a difference between the current image frame and a previous image frame;
obtaining a position-adjusted warped image by adjusting a position of the warped image frame based on a sampling position change corresponding to the jittered sampling; and
generating a current output image frame by processing the current image frame and the position-adjusted warped image frame through a neural network model.

2. The image processing method of claim 1, wherein the generating of the current image frame comprises:
performing the jittered sampling based on a first jitter offset that is predetermined for the first-resolution pixel area of the 3D scene.

3. The image processing method of claim 1, wherein the obtaining of the position-adjusted warped image comprises:
adjusting positions of pixels of the warped image frame so that an area of pixels of the warped image frame corresponds to the current image frame.

4. The image processing method of claim 3, wherein the obtaining of the position-adjusted warped image comprises:
dividing the first-resolution pixel area of the current image frame into subpixels;
obtaining a second jitter offset value corresponding to a sampling position adjusted so that positions of the subpixels of the current image frame are included in pixel areas of the warped image frame; and
adjusting the position of the warped image frame based on the second jitter offset value.

5. The image processing method of claim 4, wherein the adjusting of the position of the warped image frame based on the second jitter offset value comprises:
adjusting the position of the warped image frame so that the warped image frame is matched to a same area as the current image frame whose position is adjusted based on the second jitter offset value.

6. The image processing method of claim 5, wherein the adjusting of the position of the warped image frame comprises at least one of:
placing the warped image frame in the same area as the current image frame whose position is adjusted based on the second jitter offset value, by zero-padding and cropping the warped image frame; and
placing the warped image frame in the same area as the current image frame whose position is adjusted based on the second jitter offset value, by flipping or reflecting the warped image frame.

7. The image processing method of claim 1, wherein the generating of the output image frame comprises:
matching the position-adjusted warped image frame and the current image frame in dimension;
generating a concatenated image by concatenating the current image frame and the position-adjusted warped image frame matched in dimension; and
outputting the output image frame by inputting the concatenated image into the neural network model.

8. The image processing method of claim 7, wherein the matching in dimension comprises rearranging the position-adjusted warped image frame to correspond to a depth or a channel of the neural network model by a space-to-depth operation.

9. The image processing method of claim 1, wherein the generating of the current image frame comprises generating the current image frame by performing jittered sampling on subpixels included in the first-resolution pixel area.

10. The image processing method of claim 9, wherein
the generating of the current image frame comprises performing jittered sampling by selectively sampling respective sampling points corresponding to the subpixels, and
the sampling points are sampled alternately based on a predetermined period.

11. The image processing method of claim 1, wherein
the neural network model is configured to output the current output image frame and a feature map corresponding to the current output image frame, and
the generating of the warped image frame comprises warping the feedback image frame by applying the motion vector to the output image frame and the feature map.

12. The image processing method of claim 1, wherein the neural network model is configured to receive a first jitter offset and apply a predetermined value corresponding to the first jitter offset to the current output image frame.

13. The image processing method of claim 1, wherein the neural network model is configured to receive a first jitter offset, and output the current output image frame by applying a predetermined value corresponding to the first jitter offset to kernel weight or bias values of layers of the neural network model.

14. The image processing method of claim 1, wherein the neural network model is configured to receive a first jitter offset, and when the neural network model uses a structure of a kernel prediction network, output the current output image frame by applying a predetermined value corresponding to the first jitter offset to a filter of the kernel prediction network.

15. The image processing method of claim 14, wherein the predetermined value corresponding to the first jitter offset comprises at least one of the first jitter offset, a formula calculated using a value of the first jitter offset, and a value obtained through separate learning using the first jitter offset value as input.

16. A non-transitory computer-readable storage medium storing instructions executable by a processor, to perform:
generating a current image frame at a first resolution by performing jittered sampling on a first-resolution pixel area of a three-dimensional (3D) scene,
generating a warped image frame at a second resolution higher than the first resolution, by warping a feedback image frame based on a motion vector corresponding to a difference between the current image frame and a previous image frame,
obtaining a position-adjusted warped image by adjusting a position of the warped image frame based on a sampling position change corresponding to the jittered sampling, and
generating a current output image frame by processing the current image frame and the position-adjusted warped image frame through a neural network model.

17. An electronic device comprising:
a processor configured to:
generate a current image frame at a first resolution by performing jittered sampling on a first-resolution pixel area of a three-dimensional (3D) scene based on a first jitter offset,
generate a warped image frame at a second resolution higher than the first resolution, by warping a feedback image frame based on a motion vector corresponding to a difference between the current image frame and a previous image frame,
obtain a position-adjusted warped image by adjusting a position of the warped image frame based on a sampling position change corresponding to the jittered sampling, and
generate an output image frame by processing the jittered sample image frame and the position-adjusted warped image frame through a neural network model; and
a display configured to display the current output image frame.

18. The electronic device of claim 17, wherein the processor is further configured to adjust positions of pixels of the warped image frame so that an area of the pixels of the warped image frame corresponds to the current image frame.

19. The electronic device of claim 18, wherein the processor is further configured to:
divide the first-resolution pixel area of the current image frame into subpixels,
obtain a second jitter offset value corresponding to a sampling position adjusted so that positions of the subpixels of the current image frame are included in the pixel areas of the warped image frame, and
adjust the position of the warped image frame based on the second jitter offset value.

20. The electronic device of claim 17, wherein the processor is further configured to:
generate a concatenated image by matching the position-adjusted warped image frame and the current image frame in dimension and concatenating the current image frame and the position-adjusted warped image frame matched in dimension; and
output the current output image frame by inputting the concatenated image into the neural network model.
